(19) United States
(12) Patent Application Publication
(10) Pub. No.: US 2009/0018224 A1
(43) Pub. Date: Jan. 15, 2009

(54) PROCESS FOR THE DRYING OF FOAMS COMPOSED OF AQUEOUS PU DISPERSIONS

(75) Inventors: Meike Niesten, Koeln (DE); Steffen Hofacker, Odenthal (DE); Thorsten Rische, Unna (DE); Sebastian Doerr, Duesseldorf (DE); Thorsten Kraemer, Langenfeld (DE)

Correspondence Address: CONNOLLY BOVE LODGE & HUTZ, LLP, P O BOX 2207, WILMINGTON, DE, 19899, US

(73) Assignee: Bayer MaterialScience AG, Leverkusen (DE)

(21) Appl. No.: 12/170,820

(22) Filed: Jul. 10, 2008

(30) Foreign Application Priority Data
Jul. 11, 2007 (EP) 07013548.8
Aug. 24, 2007 (EP) 07016605.3
Oct. 19, 2007 (EP) 07020541.4

(51) Int. Cl. C08J 9/28; F26B 3/34

(52) U.S. Cl. 521/63; 34/259; 521/64

(57) ABSTRACT

The invention relates to the drying of foams by means of microwave radiation, and in particular, where the foams are obtained from aqueous polyurethane dispersions (PU dispersions).

### RELATED APPLICATION

This application claims benefit to European Patent Applications No. 07 013 548.8 filed Jul. 11, 2007, No. 07 016 605.3 filed Aug. 24, 2007 and 07 020 541.4 filed Oct. 19, 2007 the disclosure of which is incorporated by reference in its entirety.

### FIELD OF THE INVENTION

The invention relates to the microwave drying of foams, which are preferably obtained from aqueous PU dispersions.

### BACKGROUND

The coating of substrates increasingly uses aqueous binders, in particular polyurethane dispersions.

Polyurethane dispersions are particularly suitable for applications in the sector of upholstered furniture, operator protection and automobile interior equipment, because they have excellent foamability and foams and coatings produced therefrom have advantageous properties, such as good abrasion resistance, scratch resistance, buckling resistance and hydrolysis resistance. For example, it is possible in just one operation to produce foam coverings with comparatively high layer thickness, these being otherwise obtainable only with high-solids coating compositions comprising solvents (DE 10 2004 060 139).

Since foams based on aqueous polyurethane dispersions are moreover very substantially free from organic solvents and from isocyanate monomers, they can also be used for cosmetic and medical applications without further pre-treatment or purification.

Foams composed of aqueous PU dispersions are typically produced by foaming, application of the foam to a backing, and subsequent physical drying. To accelerate drying, warm air is usually used. This drying technique is, however, only suitable for foam thicknesses of at most 3 mm, based on the moist foam sublayer to be dried. A problem occurring with sublayers of greater thickness is that the foam is only superficially and partially dried, and increasingly large amounts of moisture can escape from the interior. This leads to drying behaviour which is inhomogeneous and which sometimes involves a major delay.

There was therefore a need for a process for the drying of foams composed of aqueous PU dispersions which, even for moist foam thicknesses of more than 3 mm, leads to dried foams which are homogeneous, i.e. homogeneous across the entire foam cross section, within a reasonable period, and with retention of the structure of the foam.

The drying of aqueous coatings, in particular coatings based on aqueous polyurethane dispersions, by means of microwave radiation, is disclosed by way of example in EP-A 880 001, DE-A 4 121 203 or US 2004/0253452. However, films of coatings whose layer thicknesses are at most 100 μm are always involved here, these usually being free from bubbles, i.e. without any type of foam structures.

### SUMMARY OF THE INVENTION

Surprisingly, it has now been found that microwave radiation is also suitable for drying foams produced from aqueous PU dispersions, with retention of the structure of their foams, and it is possible here to achieve simultaneous drying of the foam across the entire foam cross section.

The invention therefore provides a process for the drying of water-moist foams, preferably of those obtainable via foaming from aqueous PU dispersions and, if appropriate, from further constituents, in which the moist foam is subjected to microwave radiation.

### BRIEF DESCRIPTION OF THE DRAWINGS

FIG. 1 depicts a plot of weight loss as a function of time for the drying of foams of varying thickness using microwaves.

FIG. 2 depicts a plot of weight loss as a function of time for the dying of foams of varying thickness using a convection oven.

### DESCRIPTION OF PREFERRED EMBODIMENTS

For the purposes of the present invention, drying means lowering of the water content of a foam to be dried.

In the context of the present invention, water-moist means a water content, based on the entire foam, of at least 10% by weight, preferably from 15 to 60% by weight, particularly preferably from 35 to 60% by weight.

For the purposes of the invention, microwave radiation means electromagnetic radiation in the wavelength range from 300 MHz to 300 GHz. Radiation in the frequency ranges from 2.0 to 3.0 GHz, and also from 0.8 to 1.5 GHz, is preferred. Particularly preferred frequencies are from 2.2 to 2.6 GHz, and also from 0.85 to 1.0 GHz. Very particular preference is given to the frequencies 2.45 GHz (±0.1 GHz) and 0.915 GHz (±0.05 GHz).

Suitable aqueous PU dispersions underlying the foams to be dried are any of the dispersions known per se to the person skilled in the art and involving polyurethanes and/or polyurethane-polyureas in aqueous fluids.

Polyurethane-polyurea dispersions are preferred.

The solids contents of the PU dispersions are preferably from 40 to 63% by weight.

These PU dispersions are preferably obtainable by
A) preparing isocyanate-functional prepolymers composed of
   a1) aliphatic or cycloaliphatic polyisocyanates
   a2) polymeric polyols with number-average molar masses of from 400 to 8000 g/mol and OH functionalities of from 1.5 to 6,
   a3) if appropriate, hydroxy-functional, ionic or potentially ionic, and/or non-ionic hydrophilizing agents,
B) then entirely or partially reacting their free NCO groups with
   b1) amino-functional compounds with molar masses of from 32 to 400 g/mol and/or
   b2) amino-functional, ionic or potentially ionic hydrophilizing agents
      with chain extension, and dispersing the prepolymers in water prior to or after step B), where, if appropriate, potentially ionic groups present can be converted into the ionic form via partial or complete reaction with a neutralizing agent.

Examples of isocyanate-reactive groups are amino, hydroxy or thiol groups.

Materials typically used in a1) are 1,6-hexamethylene diisocyanates, isophorone diisocyanates, the isomeric bis(4,4′-isocyanatocyclohexyl)methanes, and also their mixtures.

It is equally possible to use modified diisocyanates having uretdione, isocyanurate, urethane, allophanate, biuret, iminooxadiazinedion and/or oxadiazinetrione structure, and it is also possible to use non-modified polyisocyanate having more than 2 NCO groups per molecule, an example being 4-isocyanatomethyl-1,8-octane diisocyanate(nonane triisocyanate) or triphenylmethane 4,4′,4″-triisocyanate.

The compounds of component a) are particularly preferably polyisocyanates or polyisocyanate mixtures of the abovementioned type having exclusively aliphatically and/or cycloaliphatically bonded isocyanate groups and having an average NCO functionality of the mixture of from 2 to 4, preferably from 2 to 2.6 and particularly preferably from 2 to 2.4.

Components used in a2) are polymeric polyols whose number-average molar masses are from 400 to 6000 g/mol, particularly preferably from 600 to 3000 g/mol. These preferably have OH functionalities of 1.8 to 3, particularly preferably from 1.9 to 2.1.

These polymeric polyols, which are known per se in polyurethane coating technology, are polyester polyols, polycarbonate polyols, polyether polyols, polyacrylate polyols, polyester polycarbonate polyols and polyether carbonate polyols. These can be used individually or in any desired mixtures with one another in a2).

The polymeric polyols used of the abovementioned type are preferably those having an underlying aliphatic skeleton. It is preferable to use aliphatic polycarbonate polyols, polyester polyols, polyether polyols, or any desired mixture thereof.

Preferred embodiments of the PU dispersions to be used with preference comprise, as component a2), a mixture composed of polycarbonate polyols and of polytetramethylene glycol polyols, where the proportion of polytetramethylene glycol polyols in the mixture is from 35 to 70% by weight and that of polycarbonate polyols is from 30 to 65% by weight, with the proviso that the total of the percentages by weight of the polycarbonate polyols and polytetramethylene glycol polyols is 100% by weight.

Hydroxy-functional, ionic or potentially ionic hydrophilizing agents a3) means any of the compounds having at least one isocyanate-reactive hydroxy group and also at least one functionality such as —COOY, —SO₃Y, —PO(OY)₂ (examples of Y being H⁺, NH₄⁺, metal cation), —NR₂, —NR₃⁺ (R═H, alkyl, aryl), where this gives a pH-dependant dissociation equilibrium on interaction with aqueous fluids and can thus have a negative or positive charge, or no charge.

Examples of suitable ionic or potentially ionic hydrophilizing compounds corresponding to the definition of component a3) are mono- and dihydroxycarboxylic acids, mono- and dihydroxysulphonic acids, and also mono- and dihydroxyphosphonic acids and their salts, e.g. dimethylolpropionic acid, dimethylolbutteric acid, hydroxypivalic acid, maleic acid, citric acid, glycolic acid, lactic acid, the propoyxlated adduct composed of 2-butenediol and NaHSO₃, described by way of example in DE-A 2 446 440 (pages 5-9, Formula I-III), and also compounds which contain, as hydrophilic structural components, units that are convertible to catonic groups, e.g. amine-based units, an example being N-methyldiethanolamine.

Preferred ionic or potentially ionic hydrophilizing agents of components a3) are those of the abovementioned type whose hydrophilizing action is anionic, preferably by way of carboxy or carboxylate and/or sulphonate groups.

Particularly preferred ionic or potentially ionic hydrophilizing agents are those which contain carboxy and/or sulphonate groups as anionic or potentially anionic groups, examples being the salts of dimethylolpropionic acid or dimethylolbutteric acid.

Examples of suitable non-ionic hydrophilizing compounds of component a3) are polyoxyalkylene ethers which contain at least one hydroxy group as isocyanate-reactive group.

Examples are the monohydroxy-functional polyalkylene oxide polyether alcohols which have a statistical average of from 5 to 70, preferably from 7 to 55, ethylene oxide units per molecule and which are obtainable in a manner known per se by alkoxylation of suitable starter molecules (for example in Ullmanns Encyclopädie technischen Chemie [Ullmann's Encyclopaedia of Industrial Chemistry], 4th Edition, Volume 19, Verlag Chemie, Weinheim pp. 31-38).

These are either pure polyethylene oxide ethers or mixed polyalkylene oxide ethers, and they contain at least 30 mol %, preferably at least 40 mol %, of ethylene oxide units, based on all of the alkylene oxide units present.

Particularly preferred non-ionic compounds are monofunctional mixed polyalkylene oxide polyethers which have from 40 to 100 mol % of ethylene oxide and from 0 to 60 mol % of propylene oxide units.

Suitable starter molecules for these non-ionic hydrophilizing agents are saturated monoalcohols, such as methanol, ethanol, n-propanol, isopropanol, n-butanol, isobutanol, sec-butanol, the isomeric pentanols, hexanols, octanols and nonanols, n-decanol, n-dodecanol, n-tetradecanol, n-hexadecanol, n-octadecanol, cyclohexanol, the isomeric methylcyclohexanols, or hyroxymethylcyclohexane, 3-ethyl-3-hydroxymethyloxetane or tetrahydrofurfuryl alcohol, diethylene glycol monoalkyl ether, e.g. diethylene glycol monobutyl ether, unsaturated alcohols, such as allyl alcohol, 1,1-dimethylallyl alcohol or oleinal alcohol, aromatic alcohols, such as phenol, the isomeric cresols, or methoxyphenols, araliphatic alcohols, such as benzyl alcohol, anisal alcohol, or cinnamyl alcohol, secondary monoamines, such as dimethylamine, diethylamine, dipropylamine, diisopropylamine, dibutylamine, bis(2-ethylhexyl)amine, N-methyl- and N-ethylcyclohexylamine or dicyclohexylamine, and also heterocyclic secondary amines, such as morpholine, pyrrolidine, piperidine or 1H-pyrazole. Preferred starter molecules are saturated monoalcohols of the abovementioned type. It is particularly preferable to use diethylene glycol monobutyl ether or n-butanol as starter molecules.

Alkylene oxides particularly suitable for the alkoxylation reaction are ethylene oxide and propylene oxide, which can be used in any desired sequence or else in a mixture during the alkoxylation reaction.

The component b1) used can comprise di- or polyamines, such as 1,2-ethylene diamine, 1,2- and 1,3-diaminopropane, 1,4-diaminobutane, 1,6-diaminohexane, isophoronediamine, and isomer mixture of 2,2,4- and 2,4,4-trimethylhexamethylenediamine, 2-methylpentamethylenediamine, diethylenetriamine, and 4,4-diaminodicyclohexylmethane and/or dimethylethylenediamine.

The component b1) used can moreover also comprise compounds which have not only a primary amino group but also secondary amino groups, or not only an amino group (primary or secondary) but also OH groups. Examples here are primary/secondary amines, such as diethanolamine, 3-amino-1-methylaminopropane, 3amino-1-ethylaminopropane, 3-amino-1-cyclohexylaminopropane, 3-amino-1-methylaminobutane, and alkanolamines, such as N-aminoethylethanolamine, ethanolamine, 3-aminopropanol, neopentanolamine.

The component b1) used can moreover also comprise monofunctional amine compounds, such as methylamine, ethylamine, propylamine, butylamine, octylamine, laurylamine, stearylamine, isononyloxypropylamine, dimethylamine, diethylamine, dipropylamine, dibutylamine, N-methyl-aminopropylamine, diethyl(methyl)aminopropylamine, morpholine, piperidine, and suitable substituted derivatives thereof, amidamines composed of diprimary amines and monocarboxylic acids, monoketimes of diprimary amines, and primary/tertiary amines, such as N,N-dimethyl-aminopropylamine.

It is preferable to use 1,2-ethylenediamine, 1,4-diaminobutane, isophoronediamine and diethylenetriamine.

The term ionic or potentially ionic hydrophilizing compounds of component b2) means any of the compounds which have at least one isocyanate-reactive amino group, and also at least one functionality such as —COOY, —SO₃Y, —PO(OY)₂ (examples of Y being H⁺, NH₄⁺, metal cation), where this gives a pH-dependant dissociation equilibrium on interaction with aqueous fluids and can thus have a positive or negative charge, or no charge.

Examples of suitable ionic or potentially ionic hydrophilizing compounds are mono- and diaminocarboxylic acids, mono- and diaminosulphonic acids, and also mono- and diaminophosphonic acids and their salts. Examples of these ionic or potentially ionic hydrophilizing agents are N-(2-aminoethyl)-β-alanine, 2-(2-aminoethylamino)ethanesulphonic acid, ethylenediaminopropyl- or -butylsulphonic acid, 1,2- or 1,3-propylenediamine-β-ethyl-sulphonic acid, glycine, alanine, taurine, lysine, 3,5-diaminobenzoic acid and the adduct of IPDI and acrylic acid (EP-A 0 916 647, Example 1). Cyclohexylaminopropanesulphonic acid (CAPS) from WO-A 01/88006 can also be used as anionic or potentially anionic hydrophilizing agent.

Preferred ionic or potentially ionic hydrophilizing agents b2) are those which contain carboxyl and/or sulphonate groups as anionic or potentially anionic groups, examples being the salts of N-(2aminoethyl)-β-alanine, or of 2-(2-aminoethylamino)ethanesulphonic acid, or of the adduct of IPDI and acrylic acid (EP-A 0 916 647, Example 1).

For the hydrophilization process, it is preferable to use a mixture composed of anionic or potentially anionic hydrophilizing agents and of non-ionic hydrophilizing agents.

During the preparation of the NCO-functional prepolymer, the ratio of NCO groups of the compounds from component a) to NCO-reactive groups from components a2) to a3) is from 1.2 to 3.0, preferably from 1.3 to 2.5.

The amount used of the amino-functional compounds in stage B) is such that the equivalence ratio of isocyanate-reactive amino groups of these compounds to the free isocyanate groups of the prepolymer is from 50 to 125%, preferably from 60 to 120%.

One preferred embodiment uses anionically and non-ionically hydrophilized polyurethane dispersions whose preparation uses the following amounts of components a1) to a3) and b1) to b2), where the individual amounts give a total of 100% by weight:
from 10 to 30% by weight of component a1),
from 65 to 85% by weight a2),
from 0.5 to 14% by weight of the component b1),
from 0.1 to 13.5% by weight of the entirety of Components a3) and b2), where from 0.5 to 3.0% by weight of anionic or potentially anionic hydrophilizing agents is used, based on the total amounts of components a1) to a3).

Particularly preferred embodiments of the polyurethane dispersions (I) comprise, as component a1), isophorone diisocyanate and/or 1,6-hexamethylene diisocyanate and/or the isomeric bis(4,4′-isocyanatocyclohexyl) methanes, in combination with a2) a mixture composed of polycarbonate polyols and of polytetramethylene glycol polyols.

These polyurethane dispersions can be prepared in one or more stages in a homogeneous phase or to some extent in a dispersed phase in the case of a multistage reaction. After complete or partial conduct of polyaddition involving at) to a3), a dispersion, emulsion, or solution step takes place. There then follows, if appropriate, a further polyaddition or modification in a disperse phase.

Any of the processes known from the prior art can be used here, examples being the prepolymer mixing process, the acetone process, or the melt dispersion process. Preference is given to the acetone process.

For preparation by the acetone process, the usual method is that some or all of the polyisocyanate component a1) for preparation of an isocyanate-functional polyurethane prepolymer and the constituents a2) to a3), which are not permitted to have any primary or secondary amino groups, is used as initial charge and diluted if appropriate with a solvent which is miscible with water but inert towards isocyanate groups, and heated to temperatures in the range from 50 to 120° C. To accelerate the isocyanate addition reaction, catalysts known in polyurethane chemistry can be used.

Suitable solvents are the conventional aliphatic, keto-functional solvents, such as acetone or 2-butanone, and these can be added not only at the beginning of the preparation but also, if appropriate, in subsequent portions. Acetone and 2-butanone are preferred.

Any constituents of a1) to a3) not added at the start of the reaction are then metered in.

Partial or complete reaction of components a1) to a3) takes place to give the prepolymer, but preferably complete reaction. This gives polyurethane prepolymers which contain free isocyanate groups, in bulk or in solution.

In a further step of the process, if this has not yet taken place or has taken place only to some extent, the resultant prepolymer is then dissolved with the aid of aliphatic ketones, such as acetone or 2-butanone.

The amine components b1) and b2) can, if appropriate, be used in water- or solvent-diluted form in the inventive process, individually or in a mixture, and in principle any sequence of addition is possible here.

If concomitant use is made of water or of organic solvents as diluent, the diluent content in the component used in B) for chain extension is preferably from 30 to 95% by weight.

Dispersion preferably follows chain extension. For this, the dissolved and chain-extended polyurethane polymer is either introduced into the dispersion water with a high level of shear, e.g. with vigorous stirring, or the inverse method is used, by stirring the dispersion water into the chain-extended polyurethane polymer solutions. It is preferable to add the water to the dissolved chain-extended polyurethane polymer.

The solvent retained in the dispersions after the dispersion step is usually then removed by distillation. It is likewise possible to carry out removal before the dispersion process has ended.

The residual content of organic solvents in the dispersions essential to the invention is typically less than 1.0% by weight, preferably less than 0.3% by weight, based on the entire dispersion.

The pH of the dispersions essential to the invention is typically less than 9.0, preferably less than 8.0.

Production of the foams to be dried can also make concomitant use of foam auxiliaries (II), thickeners (III) and other auxiliaries and additives (IV), alongside the PU dispersions.

Suitable foam auxiliaries (II) are commercially available stabilizers, such as water-soluble fatty acid amides, sulphosuccinamides, hydrocarbonsulphonates, hydrocarbon sulphates or fatty acid salts, where the lipophilic moiety preferably contains from 12 to 24 carbon atoms, alkylpolyglycosides, etc.

Preferred foam auxiliaries (II) are alkanesulphonates or alkane sulphates in each case having from 12 to 22 carbon atoms in the hydrocarbon radical, alkylbenzenesulphonates or alkylbenzene sulphates in each case having from 14 to 24 carbon atoms in the hydrocarbon radical, or fatty acid amides or fatty acid salts having from 12 to 24 carbon atoms.

The abovementioned fatty acid amides are preferably fatty acid amides of mono- or di(C2-3-alkanol)amines. Fatty acid salts can by way of example be alkali metal salts, amine salts or unsubstituted ammonium salts.

These fatty acid derivatives are typically based on fatty acids such as lauric acid, myristic acid, palmitic acid, oleic acid, stearic acid, ricinolic acid, behenic acid or arachidic acid, coconut fatty acid, talo fatty acid, soya fatty acid and hydrogenation products thereof.

Particularly preferred foam auxiliaries (II) are sodium lauryl sulphate, sulphosuccinamides and ammonium stearates, and also mixtures thereof.

For the purposes of the invention, thickeners (III) are compounds which permit adjustment of the viscosity of the resultant mixture composed of I-IV with resultant advantages for the production and processing of the inventive foam. Suitable thickeners are commercially available thickeners, such as natural organic thickeners, e.g. dextrines or starch, organically modified natural substances, e.g. cellulose ethers or hydroxyethyl cellulose, thickeners entirely prepared by organic synthesis, e.g. polyacrylic acids, polyvinylpyrrolidones, or poly(meth)acrylic compounds, or polyurethanes (associative thickeners), and also inorganic thickeners, e.g. betonites or silicas. It is preferable to use thickeners entirely prepared by organic synthesis. It is particularly preferable to use acrylate thickeners which prior to addition are, if appropriate, further diluted with water. Examples of preferred commercially available thickeners are Mirox® AM (BGB Stockhausen GmbH, Krefeld, Germany), Walocel® MT 6000 PV (Wolff Cellulosics GmbH & Co KG, Walsrode, Germany), Rheolate® 255 (Elementies Specialities, Gent, Belgium), Collacral® VL (BASF AG, Ludwigshafen, Germany), Aristoflex® AVL (Clariant, Sulzbach, Germany).

Any auxiliaries and additives present in component (IV) can by way of example be surfactants, abrasive waxes, internal release agents, fillers, dyes, pigments, flame retardants, hydrolysis stabilizers, microbicides, flow auxiliaries, antioxidants, such as 2,6-di-tert-butyl-4-methylphenol, UV absorbers of 2-hydroxyphenylbenzotriazol type, or light stabilizers of HALS-compound type, unsubstituted or substituted on the nitrogen atom, examples being Tinuvin® 292 and Tinuvin® 770 DF (Ciba Spezialitäten GmbH, Lampertheim, DE), or other commercially available stabilizers as described by way of example in “Lichtschutzmittel für Lacke” [Light stabilizers for coatings] (A. Valet, Vincentz Verlag, Hanover, 1996, and “Stabilization of Polymeric Materials” (H. Zweifel, Springer Verlag, Berlin, 1997, Appendix 3, pp. 181-213), or any mixture of these compounds.

Foam production usually uses from 80 to 99.5% by weight of PU dispersion, from 0 to 10% by weight of component (II), and from 0 to 10% by weight of component (III), where the stated quantities are based on the corresponding anhydrous components (I) to (III), and the entirety of the anhydrous individual components gives 100% by weight.

Foam production usually uses from 80 to 99.5% by weight of PU dispersion, from 0.1 to 10% by weight of component (II), and from 0.1 to 10% by weight of component (III), where the stated quantities are based on the corresponding anhydrous components (I) to (III), and the entirety of the anhydrous individual components gives 100% by weight.

The foam can be produced via introduction of air and/or with exposure to appropriate shear energy (e.g. mechanical stirring) or via commercially available blowing agents. Preference is given to the introduction of air with exposure to appropriate shear energy.

The foamed composition can be applied in a very wide variety of ways to a very wide variety of surfaces, or in moulds, examples being casting, doctor-application, rolling, spreading, injection or spraying; shaping via an extrusion process is equally possible.

While the preferred foam density of the foamed material prior to drying is from 200 to 900 g/l, particularly from 250 to 600 g/l, the density of the resultant foams after drying is preferably from 50 to 700 g/l , particularly preferably from 200 to 550 g/l.

The actual drying takes place via exposure to microwave radiation within the abovementioned frequency ranges.

The power introduced at the abovementioned frequencies is preferably from 250 to 6000 W, particularly preferably from 500 to 4000 W, per kilogram of foam to be dried.

It is moreover possible, alongside the use of microwave radiation, also to use a combination composed of microwave radiation and of conventional thermal drying, by using IR radiation and/or hot air to heat the foam to be dried. It is unimportant here whether the two types of drying are used in parallel with one another or in succession. In the case of successive drying by means of microwave radiation and heat treatment it is preferable first to carry out drying by means of microwave radiation and then to carry out the heat treatment.

The inventive process can give homogeneous drying of foams up to & height of 50 mm, where the term height relates to that spatial direction in which the foam has the smallest dimension.

One preferred embodiment of the process dries the foam sheets of height up to 30 mm that can be produced by means of casting processes.

Equally preferred is the drying of the foam strands preferably obtained in the extrusion process, where the height and width of the strand is in case from 1 to 30 mm, preference being given to a height of from 5 to 30 mm and a width of from 1 to 30 mm.

Preference is further given to the drying of the foams that can be obtained by means of mould casting processes, where the dimension of the foams in relation to each of height, width and length is from 1 to 30 mm.

The inventive foams can also be applied in a plurality of layers, for example to produce particularly high foam coverings, to a very wide variety of substrates, or can be cast in moulds.

The inventive foamed compositions can moreover also be used in combination with other backing materials, e.g. textile backings, paper, etc., for example via prior application (e.g. coating).

The best drying results are achieved when the foams used for drying have a height of from 1 to 30 mm, preferably from 1 to 20 mm, examples being foams that can be produced by means of doctor-application, casting or extrusion.

The inventive process provides access to a number of new modes of application, examples being use of a casting process for shaping, and extrusion, if appropriate followed by cutting. Particularly good foams are moreover obtained by casting the undried foam in a powder mould, e.g. starch or silica, and then drying them in a microwave.

To produce relatively high foam thicknesses, it is also possible to apply these in a plurality of layers to a very wide variety of substrates or to cast them in moulds.

### EXAMPLES

All percentages are based on weight, unless otherwise indicated.

Solids contents were determined to DIN-EN ISO 3251.

NCO contents were determined volumetrically to DIN-EN ISO 11909, unless expressly otherwise mentioned.

### Substances and Abbreviations Used:

| | |
|---|---|
| Diaminosulphonate: | NH₂—CH₂CH₂—NH—CH₂CH₂—SO₃Na (45% strength in water) |
| Desmophen ® C2200: | Polycarbonatepolyol, OH number 56 mg KOH/g, number-average molar |
| | mass 2000 g/mol (Bayer MaterialScience AG, Leverkusen, DE) |
| PolyTHF ® 2000: | Polytetramethylene glycol polyol, OH number 56 mg KOH/g, number- |
| | average molar mass 2000 g/mol (BASF AG, Ludwigshafen, DE) |
| PolyTHF ® 1000: | Polytetramethylene glycol polyol, OH number 112 mg KOH/g, number- |
| | average molar mass 1000 g/mol (BASF AG, Ludwigshafen, DE) |
| Polyether LB 25: | Monofunctional polyether based on ethylene oxide/propylene oxide, |
| | number-average molar mass 2250 g/mol, OH number 25 mg KOH/g |
| | (Bayer MaterialScience AG, Leverkusen, DE) |
| Stokal ® STA: | 30% of ammonium stearates in water, foam stabilizer (Bozzetto GmbH, |
| | Krefeld, DE) |
| Aristoflex AVL: | Dispersion of a polymeric sulphonic acid and emulsifiers in |
| | caprylic/capric acid triglyceride (Clariant, Muttenz, Switzerland) |
| Loxanol K12P: | Sodium lauryl sulphate (Cognis, Düsseldorf, DE) |

Average particle sizes (the stated value being the number average) of the PU dispersions were determined by means of laser correlation spectroscopy (equipment: Malvern Zetasizer 1000, Malvern Inst. Limited).

### Example 1

### PU Dispersion (Component I)

761.3 g of Desmophen® C2200, 987.0 g of PolyTHF® 2000, 375.4 g of PolyTHF® 1000 and 53.2 g of Polyether LB 25 were heated to 70° C. A mixture composed of 237.0 g of hexamethylene diisocyanate and 313.2 g of isophorone diisocyanate was then added within a period of 5 min at 70° C. and the mixture was stirred at reflux until the theoretical NCO value had been achieved. The finished prepolymer was dissolved at 50° C. in 4850 g of acetone and then a solution composed of 1.8 g 25.1 g of ethylenediamine, 61.7 g of diaminosulsphonate, 116.5 g of isophoronediamine and 1030 g of water was metered in within a period of 10 min. Stirring was continued for 10 min. Dispersion was then achieved via addition of 1061 g of water. The solvent was then removed via distillation in vacuo, giving a storage-stable dispersion whose solids content was 60%.

### Example 2 to 7

### Production of Inventive Foams

10 000 g of the dispersion (I) obtained from Example 1 were mixed with 90 g of Loxanol K12P (II), 150 g of Stokal STA (II), and 150 g of Aristoflex AVL (III), and then foamed via introduction of air with the aid of a Hansamixer Top-Mix-K (Hansa Industrie Mixer GmbH, Heiligenrode, DE). The density of the resultant foam was 500 g/l. The foam was applied in layers of 3, 5, 8, 10, 13 and 15 mm, with width of 15 cm, to a release paper (VEZ Mat, Sappi, Brussels, Belgium). Finally, the resultant foams were applied to a porous textile (Sefar Propyltex 05-1000/45 mm mesh width, Sefar GmbH, Wasserburg, Germany) and placed 5 cm above the base of a MWT k/1,2-3 LK reg. laboratory microwave system from EL-A Verfahrenstechnik (Heidelberg, DE), and dried for 30 min at 30% power level (3.6 kW at maximum power).

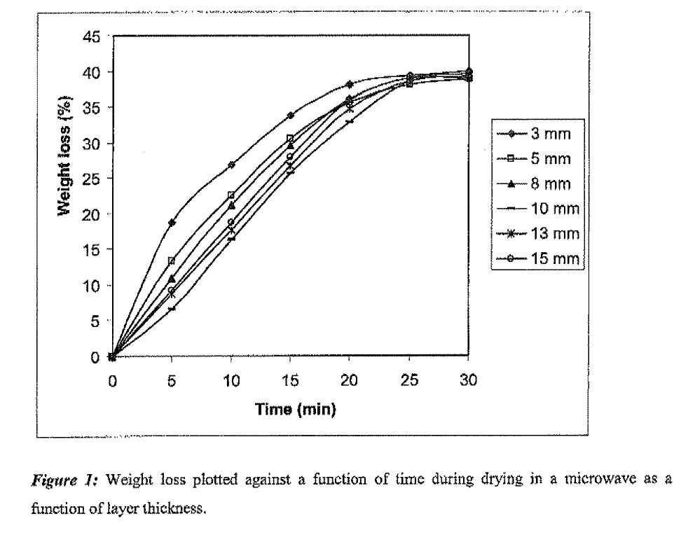

FIG. 1 shows that, irrespective of the layer thickness, the foams to be dried were found to have constant weight after 30 min. The weight loss arising here in comparison with the moist foam material corresponded to the value expected on the basis of the water present.

### Example 8 to 13

### Comparative Examples

10 000 g of the dispersion (I) obtained from Example 1 were mixed with 90 g of Loxanol K12P (II), 150 g of Stokal STA (III), and 150 g of Aristoflex AVL (IV), and then foamed via introduction of air with the aid of a Hansamixer Top-Mix-K (Hansa Industrie Mixer GmbH, Heiligenrode, DE). The density of the resultant foam was 500 g/l. The foam was applied in layers of 3, 5, 8, 10, 13 and 15 mm, with width of 15 cm, to a release paper (VEZ Mat, Sappi, Brussels, Belgium). The material was then dried in a convection oven using a temperature profile of 60° C. (30 min), 90° C. (30 min) and 110° C. (15 min).

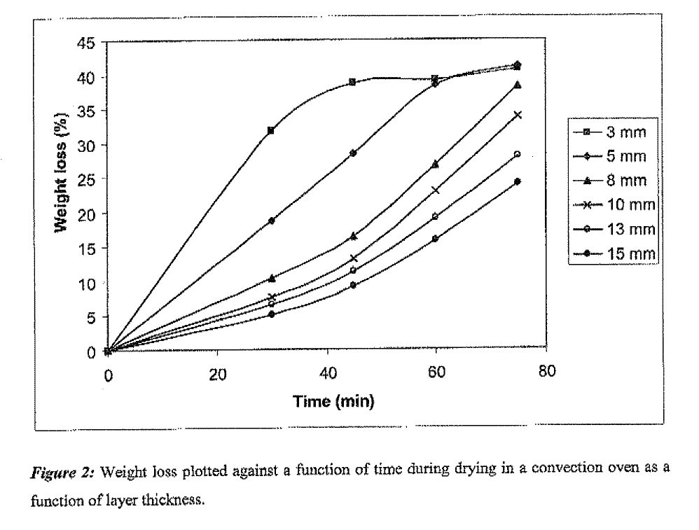

As can be seen from FIG. 2, after 75 min it was quite impossible to obtain a dried material except at a layer thickness of 3 mm. In all other cases, 75 min were insufficient to obtain constant weight, or the final dry foam weight expected on the basis of the water content. Irrespective of the degree of drying, all of the foams had an irregular foam structure (e.g. cavities and bubbles).

### Example 14

### Inventive Example (Extrusion)

10 000 g of the dispersion (I) obtained from Example 1 were mixed with 90 g of Loxanol K12P (III), 150 g of Stoical STA (III), and 150 g of Aristoflex AVL (IV), and then foamed via introduction of air with the aid of a Hansamixer Top-Mix-K (Hansa Industrie Mixer GmbH, Heiligenrode, DE). The density of the resultant foam was 500 g/l. 470 grams of the foamed paste were then applied via a tube whose diameter was 15 mm in strips to release paper (VEZ, Mat, Sappi, Brussels, Belgium), and then applied to a porous textile (Sefar Propylex 05-1000/45 mm mesh width, Sefar GmbH, Wasserburg, Germany) and placed 5 cm above the base of a MWT k/1,2-3 LK reg. laboratory microwave system from EL-A. Verfahrenstechnik (Heidelberg, DE), and dried for 30 min at 30% power level (3.6 kW at maximum power).

The weight loss measured here was 188 g (40% by weight), corresponding to the amount of water originally present in the foam. The foam had a fine uniform structure.

All documents mentioned herein are incorporated by reference to the extent relevant to making, using or describing the present invention.

What is claimed is:

1. A process for drying foams, which comprises subjecting a water-moist foam to microwave radiation.

2. The process according to claim 1, wherein the water content of the water-moist foam to be dried is from 15 to 60% by weight.

3. The process according to claim 1, wherein the microwave radiation comprises electromagnetic radiation whose frequency is in the range from 2.0 to 3.0 GHz or from 0.8 to 1.5 GHz.

4. The process according claim 1, wherein thermal drying is additionally carried out in parallel, prior to, or after the drying by means of microwave radiation.

5. The process according to claim 1, wherein the water-moist foam to be dried is obtained from an aqueous PU dispersion and optionally further constituents, via foaming.

6. The process according to claim 5, wherein the PU dispersions are polyurethane dispersions or polyurethane-polyurea dispersions with solids contents of from 40 to 63% by weight.

7. The process according to claim 5, wherein the PU dispersion is obtained by
A) preparing isocyanate-functional prepolymers composed of
a1) aliphatic or cycloaliphatic polyisocyanates
a2) polymeric polyols with number-average molar masses of from 400 to 8000 g/mol and OH functionalities of from 1.5 to 6,
a3) if appropriate, hydroxy-functional, ionic or potentially ionic, and/or non-ionic hydrophilizing agents,
B) then entirely or partially reacting their free NCO groups with
b1) amino-functional compounds with molar masses of from 32 to 400 g/mol and/or
b2) amino-functional, ionic or potentially ionic hydrophilizing agents with chain extension, and dispersing the prepolymers in water prior to or after step B), where, optionally, potentially ionic groups present are converted into the ionic form via partial or complete reaction with a neutralizing agent.

8. The process according to claim 7, wherein, during the preparation of the PU dispersions, the component a1) comprises isophorone diisocyanate and/or 1,6-hexamethylene diisocyanate and/or the isomeric bis(4,4′-isocyanatocyclohexyl)methanes in combination with a2) a mixture composed of polycarbonate polyols and of polytetramethylene glycol polyols.

9. The process according to any of claim 1, wherein the foam density of the water-moist foams prior to drying is from 250 to 600 g/l, and their foam density after drying is from 200 to 550 g/l.

10. The process according to claim 1, wherein the water-moist foams are foam sheets whose height is at most 30 mm, foam strands whose height is from 5 to 30 mm and whose width is from 1 to 30 mm, or mouldings whose dimension, in relation to each of length, width and height is from 1 to 30 mm.
